(19) United States
(12) Patent Application Publication
(10) Pub. No.: US 2023/0017415 A1
(43) Pub. Date: Jan. 19, 2023

(54) INTERACTIVE TEXTILE AND METHOD OF FORMING THE SAME

(71) Applicant: Robert Bosch GmbH, Stuttgart (DE)

(72) Inventors: Jin Han Jeon, Singapore (SG); Philipp Scheiner, Weil Der Stadt (DE); Yong Heng So, Singapore (SG)

(21) Appl. No.: 17/784,992

(22) PCT Filed: Jan. 29, 2020
(86) PCT No.: PCT/EP2020/052112

§ 371 Date: Jun. 13, 2022

(51) Int. Cl. D03D 1/00; G06F 3/01

(52) U.S. Cl. CPC D03D 1/0088; G06F 3/016; D10B 2401/18

(57) ABSTRACT

An interactive textile configured to provide a haptic feedback in response to an activating signal. The interactive textile includes a fabric; an electroactive layer disposed on the fabric, the electroactive layer having a first main side and a second main side; a first electrode disposed between the first main side of the electroactive layer and the fabric; and a second electrode disposed on the second main side of the electroactive layer. A method of forming an interactive textile configured to provide a haptic feedback in response to an activating signal is also provided.

### FIELD

The present disclosure relates to an interactive textile. The present disclosure further relates to a method of forming an interactive textile.

### BACKGROUND INFORMATION

Smart textiles are defined as tech-infused textiles with integrated functionalities for electronic components such as sensors, actuators and/or other types of transducers in textile structures.

Smart textile systems including shape memory materials, conducting polymer fibers, and nylon yarn actuators are available for kinetic actuation and static movement (not dynamic vibrational haptic feedback). Therefore, conventional smart textile systems are not applicable for high-strength vibrational haptic feedback applications due to their slow response and low force generation. In addition, they still exhibit nonlinear actuation performance due to thermal/heat control as well as long cooling duration.

One of the approaches to realize vibrational haptic and actuation features on fabrics for Human Machines Textile Interface is an application of conventional bulky actuators to textiles. A conventional haptic-feedback interface was achieved via attaching vibratory motors, such as eccentric rotating mass (ERM) or linear resonant actuators (LRA), mounted underneath (or at the edge of) the touch interface to generate completely vibrational haptic. Smart clothing for haptic feedback belt, vest, or shirt was introduced by sewing LRA into clothing. However, these haptic actuators may have several limitations particularly due to their bulky size, complex mechanical design and are limited to whole structure vibration. For example, these haptic actuators may not fit with lightweight fabric applications due to their bulky size and/or heavy weight.

### SUMMARY

It is an objective of the present invention to provide an improved interactive textile which can provide haptic feedback.

Various example embodiments of the present invention may provide an interactive textile configured to provide a haptic feedback in response to an activating signal. The interactive textile may include a fabric. The interactive textile may include an electroactive layer disposed on the fabric, the electroactive layer having a first main side and a second main side. The interactive textile may include a first electrode disposed between the first main side of the electroactive layer and the fabric; and a second electrode disposed on the second main side of the electroactive layer.

Various example embodiments of the present invention may provide a method of forming an interactive textile configured to provide a haptic feedback in response to an activating signal. The method may include providing a fabric. The method may include disposing a first electrode on the fabric. The method may include disposing an electroactive layer on the first electrode. The method may include disposing a second electrode on the electroactive layer.

### BRIEF DESCRIPTION OF THE DRAWINGS

In the following description, various example embodiments of the present invention are described with reference to the following figures.

FIG. 1A shows a schematic illustration of a cross section of an interactive textile according to various embodiments of the present invention.

FIG. 1B shows a schematic illustration of a cross section of an interactive textile according to various embodiments of the present invention.

FIG. 2A shows a schematic illustration of a cross section of an interactive textile according to various embodiments of the present invention.

FIG. 2B shows a schematic illustration of a cross section of an interactive textile according to various embodiments of the present invention.

FIG. 3 shows a schematic illustration of a cross section of an interactive textile according to various embodiments of the present invention.

FIG. 4 shows a schematic illustration of an interactive textile according to various embodiments of the present invention.

FIG. 5 shows a schematic illustration of an interactive textile according to various embodiments of the present invention.

FIG. 6A shows a schematic illustration of an interactive textile according to various embodiments of the present invention.

FIGS. 6B and 6C show schematic illustrations of the stretchable properties of the interactive textile according to various embodiments of the present inventions.

The figures are of schematic nature and elements therein may be of different scale or positioned differently to improve readability.

### DETAILED DESCRIPTION OF EXAMPLE EMBODIMENTS

The following detailed description describes specific details and embodiments in which the present invention may be practiced. These embodiments are described in sufficient detail to enable those skilled in the art to practice the present invention. Other embodiments may be utilized and changes may be made without departing from the scope of the present invention. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present invention illustratively described herein may suitably be practiced in the absence of any element or elements, limitation or limitations, not specifically disclosed herein. Thus, for example, the terms “comprising”, “including”, containing”, etc. shall be read expansively and without limitation. The word “comprise” or variations such as “comprises” or “comprising” will accordingly be understood to imply the inclusion of a stated integer or groups of integers but not the exclusion of any other integer or group of integers. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the present invention. Thus, it should be understood that although the present disclosure has been specifically disclosed by exemplary embodiments and optional features, modification and variation of the disclosures embodied herein disclosed may be resorted to by those skilled in the art, and that such modifications and variations are considered to be within the scope of the present invention.

As used herein, the term “overlap” may mean that the respective layers are at least partially present when viewed in a same direction.

As used herein, the term “embedded’ may mean at least partially penetrating. For example, a disposed layer at least partially penetrating a fabric. This may have an advantage of enhancing adhesion between the over-coated layer and the fabric, and smoothening the surface roughness of an electrode or an interface layer. Penetrating a fabric may mean disposed in the space between adjacent fibers of the fabric. Alternatively or in addition, penetrating a fabric may mean penetrating in a fiber of the fabric.

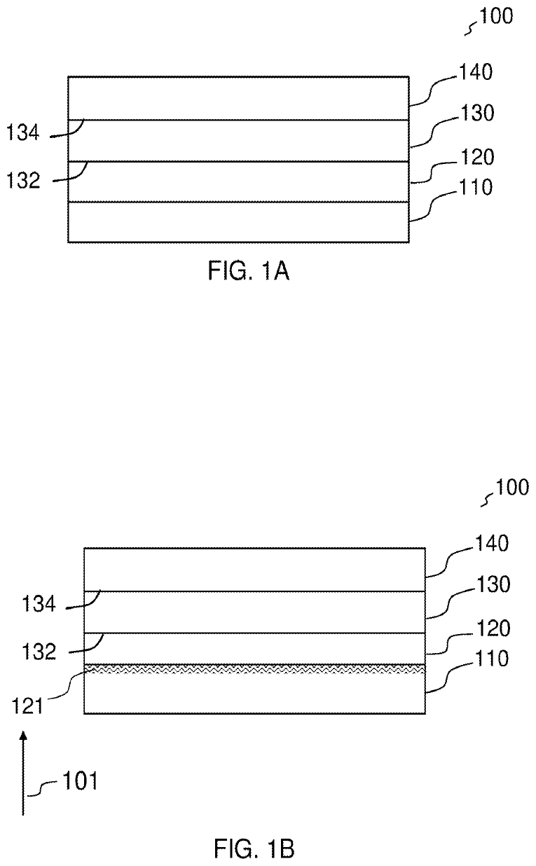

FIG. 1A shows a schematic illustration of a cross section of an interactive textile according to various embodiments.

According to various embodiments, an interactive textile 100 configured to provide a haptic feedback in response to an activating signal may be provided. The interactive textile 100 may include a fabric 110. An electroactive layer 130 may be disposed on the fabric 110. The electroactive layer 130 may have a first main side 132 and a second main side 134. A first electrode 120 may be disposed between the first main side 132 of the electroactive layer 130 and the fabric 110. A second electrode 140 may be disposed on the second main side 134 of the electroactive layer 130.

In various embodiments, a main side may be a longer side of the electroactive layer 130. The electroactive layer 130 may have more than one main side, for example the first main side 132 and the second main side 134. The first main side 132 and the second main side 134 may be opposite each other.

In various embodiments, the fabric 110, the first electrode 120, the electroactive layer 130 and the second electrode 140 may be disposed on each other in a first direction 101. The first direction 101 may be perpendicular to a surface of the fabric 110.

In various embodiments, the fabric may be one of woven, knitted, braided, tufted, crocheted, or non-woven. Woven fabrics may include at least one of or be made of: cotton, PES (polyether sulfone) and a blend of natural cotton and synthetic polyester (Poly cotton). Knitted fabrics may include at least one of or be made of: PA66 (polyamide 66, commercially known as Nylon 66), PA6 (polyamide 6, commercially known as Nylon 6), PES, PES-EL (e.g. 81% PES, 19% EL (elastane)). Non-woven fabric may include at least one of or be made of: fleece and PES-PA (Polyester and Polyamide chips are spun into endless segmented filaments).

In various embodiments, the first electrode 120 and the second electrode 140 may be, for example individually selected from: poly(3,4-ethylenedioxythiophene) polystyrene sulfonate (PEDOT:PSS), Indium Tin Oxide (ITO), silver nanowires (AgNWs), graphene, and carbon nanotubes (CNTs). An advantage of using PEDOT:PSS for the first electrode 120 and/or second electrode 140 may be that PEDOT:PSS is easily screen printable on fabric 110.

In various embodiments, an electrical power, for example a voltage difference, may be provided to the first electrode 120 and the second electrode 140.

In various embodiments, the term “electroactive layer” may mean a layer which may undergo a shape change in response to an applied electrical field or a voltage difference, and/or a layer which may emit an electrical signal upon touch or motion. The electrical signal may be detected via electrodes disposed on sides of the electroactive layer. The electroactive layer may include an electroactive material, e.g. an electroactive polymer (EAP). Examples of electroactive materials may include: dielectric EAP (dEAP), piezo electric active polymer (piezoEAP). Examples of piezoEAPs are: FerroEAPs such as poly (vinylidenefluoride-trifluoroethylene-chlorotrifluoroethylene) abbreviated as P(VDF-TrFE-CTFE), poly(vinylidenefluoride-trifluoroethylene-chlorofluoroethylene) abbreviated as P(VDF-TrFE-CFE), poly(vinylidenefluoride-trifluoroethylene-hexafluoropropylene) abbreviated as P(VDF-TrFE-HFP), and poly[(vinylidenefluoride-co-trifluoroethylene] abbreviated as P(VDF-TrFE), poly[(vinylidenefluoride-co-hexafluoropropylene] abbreviated as P(VDF-HFP), poly[(vinylidenefluoride-co-chlorotrifluoroethylene] abbreviated as P(VDF-CTFE).

Examples of dielectric EAPs are: acrylic elastomers, silicon elastomers, fluoroelastomers, polyurethane, natural/synthetic rubbers.

In various embodiments, the haptic feedback is one of actuation or vibration. The haptic feedback may be above 10 mN/cm².

In various embodiments, the activating signal may occur upon touch or motion of the interactive textile 100. For example, upon pressing of the interactive textile 100. In various embodiments, the activating signal may be an electrical signal.

Although the interactive textile is shown to be rectangular, disclosure is not limited thereto. The interactive textile may be of any suitable shape, for example, a circle.

In various embodiments, the interactive textile 100 may be wearable, for example as a clothing such as a shirt or as an accessory such as a belt. This may result in smart clothing or accessories that may be interactive resulting in a better user experience. For example, when the user touches the interactive textile 100, a haptic feedback for example a vibration may occur. This may be useful for a range of purposes such as in fitness clothing or for medical purposes.

FIG. 1B shows a schematic illustration of a cross section of an interactive textile according to various embodiments.

The interactive textile of FIG. 1B may have a similar structure as the interactive textile of FIG. 1A. The explanations to the interactive textile of FIG. 1A are applicable to the interactive textile of FIG. 1B.

In various embodiments, the first electrode 120 may be embedded or at least partially embedded into the fabric 110. The first electrode 120 and the fabric 110 may overlap or at least partially overlap in the first direction 101. The first electrode 120 may act as a basement layer. In FIG. 1B, the overlap between the first electrode 120 and the fabric 110 is shown as embedded portion 121 of the first electrode 120.

In various embodiments, for example due to high surface roughness, non-flat surface and porous structure of fabrics, overlapping and/or embedding the first electrode 120 and the fabric 110 may have the advantage of better adhesion between the first electrode 120 and the fabric 110. This may result in smoothening the surface roughness of the fabric and which may result in better quality adhesion of the subsequent layers (e.g. electro-active layer and second electrode).

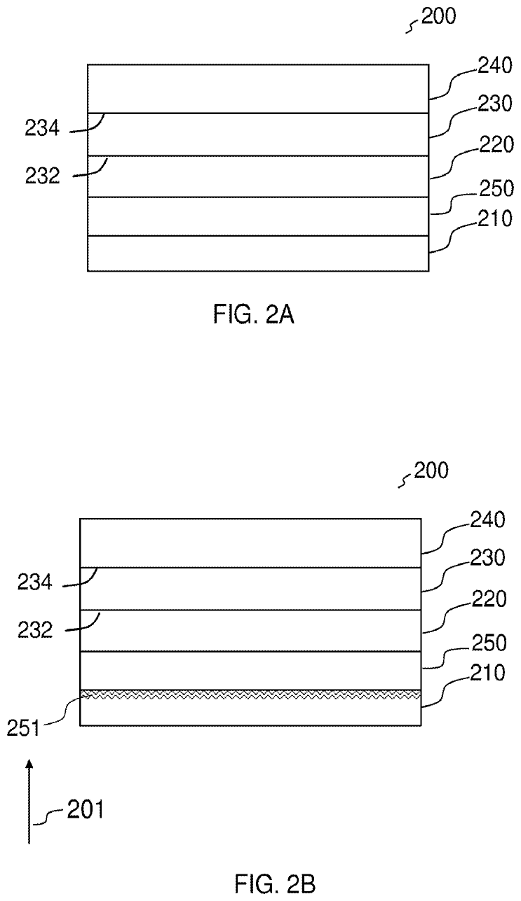

FIG. 2A shows a schematic illustration of a cross section of an interactive textile 200 according to various embodiments.

The interactive textiles of FIG. 2A may have a similar structure as the interactive textile of FIGS. 1A and 1B. The discussion of the interactive textiles of FIGS. 1A and 1B is applicable to the interactive textile of FIG. 2A.

The interactive textile 200 may include a fabric 210. In various embodiments, an electroactive layer 230 may be disposed on the fabric 210. The electroactive layer 230 may have a first main side 232 and a second main side 234. A first electrode 220 may be disposed between the first main side 232 of the electroactive layer 230 and an interfacial layer 250. The interfacial layer 250 may be disposed on the fabric 210. The interfacial layer 250 may be disposed between the first electrode 220 and the fabric 210. A second electrode 240 may be disposed on the second main side 234 of the electroactive layer 230. In various embodiments, the interfacial layer 250 may smoothen the surface roughness of the fabric 210. In various embodiments, the interfacial layer 250 may be polyurethane based. For example, the interfacial layer 250 may be polyurethane acrylate based. The interfacial layer 250 may be thermoplastic polyurethane film (TPU) foils. The TPU foil may be laminated to fabric 210 using a lamination process, for example a hot lamination process. The lamination process may be conducted with heating, e.g., at a temperature between 130 to 150 degree Celsius. The lamination process may be conducted using a relatively low speed e.g., of around 0.5 metre per minute to 1 metre per minute, for example 0.5 metre per minute. The lamination process may be conducted using relatively gentle pressure of less than 5 bar, for example 4 bar.

FIG. 2B shows a schematic illustration of a cross section of an interactive textile 200 according to various embodiments.

The interactive textiles of FIG. 2B may have a similar structure as the interactive textile of FIGS. 1A, 1B and 2A. The explanations to the interactive textiles of FIGS. 1A, 1B and 2A are applicable to the interactive textile of FIG. 2B.

In various embodiments, the interfacial layer 250 may be embedded or at least partially embedded into the fabric 210. The interfacial layer 250 and the fabric 210 may overlap or at least partially overlap in the first direction 201. The interfacial layer 250 may act as a basement layer. In FIG. 2B, the overlap between the interfacial layer 250 and the fabric 210 is shown as embedded portion 251 of the interfacial layer 250.

In various embodiments, for example due to high surface roughness, non-flat surface and porous structure of fabrics, overlapping and/or embedding the interfacial layer 250 and the fabric 210 may have the advantage of better adhesion between the interfacial layer 250 and the fabric 210. This may result in smoothening the surface roughness of the fabric and which may result in better quality adhesion of the subsequent layers (e.g. first electrode, electro-active layer and second electrode).

According to various embodiments, actuation behavior and vibration modes may be adjusted by at least one of: selecting the actuating layer patterns to be printed, selecting numbers of layers, selecting thickness of each layer, selecting fabric types, selecting yarn materials, and selecting fabric density.

In various embodiments, a surface of the fabric may be treated before disposing the interfacial layer on the fabric. Prior to the electrode or actuating layer deposition, a surface treatment may be applied on the textile/fabrics (e.g. plasma treatment —O2, Ar, other surface roughening processes to induce hydroxyl (—OH) groups on the surface through surface modification, and applying an interfacial layer to enhance the adhesion and bonding properties between the electrode, the actuating layer and the fabric. This may help in better binding between the electrode, the actuating layer and the fabric.

In various embodiments, the interfacial layer may be printed prior to the coating with active inks. In various embodiments, UV- or thermal-curable and screen-printable polyurethane acrylate based interface paste may be a good interface layer to smoothen the surface roughness. It may be applied on various textiles, including cotton, polyester as well as any flexible substrate. This may result in good adhesion to various textiles, good flexibility and surface smoothness, which may increase quality of layers and may better mechanical properties such as less cracking, higher durability, higher robustness and higher conductivity.

In various embodiments, the interactive textile 200 may be wearable, for example as a clothing such as a shirt or as an accessory such as a belt. This may result in smart clothing or accessories that may be interactive resulting in a better user experience. For example, when the user touches the interactive textile 200, a haptic feedback for example a vibration may occur. This may be useful for a range of purposes such as in fitness clothing or for medical purposes.

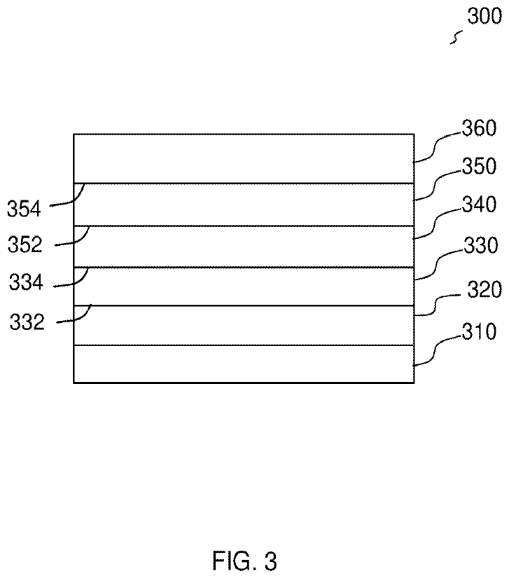

FIG. 3 shows a schematic illustration of a cross section of an interactive textile 300 according to various embodiments.

According to various embodiments, the interactive textile may include more than one electroactive layer. The interactive textile may include a second electroactive layer. For (n)-th electroactive layer, the number of electrodes may be (n+1) where n is a positive integer equal or greater than 1. The interactive textile may include more of such electroactive layers in between electrodes to form an interactive textile with multiple electroactive layers.

According to various embodiments, an interactive textile 300 configured to provide a haptic feedback in response to an activating signal may be provided. The activating signal may be an electrical signal. The interactive textile 300 may include a fabric 310. A first electroactive layer 330 may be disposed on the fabric 310. The first electroactive layer 330 may have a first main side 332 and a second main side 334. A first electrode 320 may be disposed between the first main side 332 of the first electroactive layer 330 and the fabric 310. A second electrode 340 may be disposed on the second main side 334 of the first electroactive layer 330. In various embodiments, a second electroactive layer 350 may be disposed on the second electrode 340. The second electroactive layer 350 may have a first main side 352 and a second main side 354. The first main side 352 of the second electroactive layer 350 may be on the second electrode 340. A third electrode 360 may be disposed on the second main side 354 of the second electroactive layer 350.

In various embodiments, a main side may be a longer side of the first electroactive layer 330 and/or the second electroactive layer 350. The first electroactive layer 330 and/or the second electroactive layer 350 may have more than one main sides, for example two main sides, for example, the first main side 332 and the second main side 334 of the first electroactive layer 330 and the first main side 352 and the second main side 354 of the second electroactive layer 350. The first main side 332 and the second main side 334 of the first electroactive layer 330 may be opposite each other. The first main side 352 and the second main side 354 may be opposite sides of the second electroactive layer 350. The first main side 332 of the first electroactive layer 330 may be the side facing the fabric 310. The first main side 352 of the second electroactive layer 350 may be the side facing the fabric 310.

In various embodiments, an electrical power, for example, a voltage difference, may be provided to the first electrode 320, the second electrode 340 and the third electrode 360.

In various embodiments, the first electrode 320 may be embedded or at least partially embedded into the fabric 310. The first electrode 320 and the fabric 310 may overlap or at least partially overlap in the first direction. The first electrode 320 may act as a basement layer.

In various embodiments, for example, due to high surface roughness, non-flat surface and porous structure of fabrics, overlapping and/or embedding the first electrode 320 and the fabric 310 may have the advantage of better adhesion between the first electrode 320 and the fabric 310. This may result in smoothening the surface roughness of the fabric and which may result in better quality adhesion of the subsequent layers (e.g. first electro-active layer, second electrode, second electro-active layer and third electrode).

In various embodiments, an interfacial layer (not shown) may be disposed between the first electrode 320 and the fabric 310. The interfacial layer may be configured to smooth the surface roughness of the fabric 310.

In various embodiments, the interfacial layer may be embedded or at least partially embedded into the fabric 310. The interfacial layer and the fabric 310 may overlap or at least partially overlap in the first direction. The interfacial layer may act as a basement layer.

In various embodiments, for example, due to high surface roughness, non-flat surface and porous structure of fabrics, overlapping and/or embedding the interfacial layer and the fabric 310 may have the advantage of better adhesion between the interfacial layer and the fabric 310. This may result in smoothening the surface roughness of the fabric and which may result in better quality adhesion of the subsequent layers (e.g. first electrode, first electro-active layer, second electrode, second electro-active layer and third electrode).

In various embodiments, the interactive textile 300 may be wearable, for example as a clothing such as a shirt or as an accessory such as a belt. This may result in smart clothing or accessories that may be interactive resulting in a better user experience. For example, when the user touches the interactive textile 300, a haptic feedback for example a vibration may occur. This may be useful for a range of purposes such as in fitness clothing or for medical purposes.

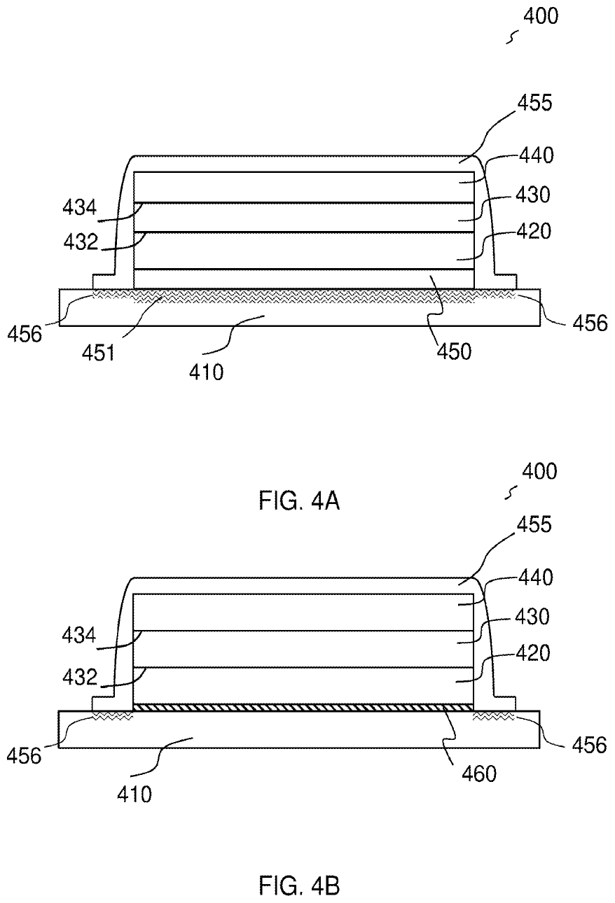

FIGS. 4A and 4B show a schematic illustration of an interactive textile 400 according to various embodiments.

In various embodiments, the interactive textile 400 may include a fabric 410. In various embodiments, an electroactive layer 430 may be disposed on the fabric 410. The electroactive layer 430 may have a first main side 432 and a second main side 434. A first electrode 420 may be disposed between the first main side 432 of the electroactive layer 430 and an interfacial layer 450. The interfacial layer 450 may be disposed on the fabric 410. A second electrode 440 may be disposed on the second main side 434 of the electroactive layer 430.

In various embodiments, the interfacial layer 450 may smoothen the surface roughness of the fabric 410. In various embodiments, the interfacial layer 450 may be embedded or at least partially embedded into the fabric 410. The interfacial layer 450 and the fabric 410 may overlap or at least partially overlap in the first direction. The interfacial layer 450 may act as a basement layer. In FIG. 4A, the overlap between the interfacial layer 450 and the fabric 410 is shown as embedded portion 451 of the interfacial layer 450.

In various embodiments, for example, due to high surface roughness, non-flat surface and porous structure of fabrics, overlapping and/or embedding the interfacial layer 450 and the fabric 410 may have the advantage of better adhesion between the interfacial layer 450 and the fabric 410. This may result in smoothening the surface roughness of the fabric and which may result in better quality adhesion of the subsequent layers (e.g. first electrode, electro-active layer and second electrode).

In various embodiments, a protective layer 455 may also be disposed on second electrode 440. The protective layer 455 may also be disposed on the sides of the first electrode 420, the electroactive layer 430 and the second electrode 440, for example, as portion 456.

In various embodiments, a portion 456 of the protective layer 455 may contact the fabric and be embedded or at least partially embedded into the fabric 410. The overlap between portion 456 and the fabric may be 45% or less, for example selected from 10% to 25% of the total overlap between the protective layer 455 and the fabric.

In various embodiments, a gap 460 (e.g. an air gap) may be formed between the first electrode 420 and the fabric 410. When pressure, for example a pressing force, is applied on the interactive textile, the first electrode 420 may be pressed in contact with the fabric 410 in FIG. 4B. A portion (e.g. a center) of the electroactive layer 430 may be able to freely vibrate though gap 460 without constraint, compared to an embodiment where the whole structure is fixed and constrained along with the fabric substrate which may slightly reduce the vibration amplitude.

In various embodiments, the electrodes 420, 440 and electroactive layer 430 may be directly printed on the interfacial layer 455 which may act as the protective layer. The electrodes 420, 440, the electroactive layer 430 and the interfacial layer 455 may be transferred to target fabrics via hot pressing (hot lamination), roll lamination or heat transfer machine. The layers may be easily integrated into the fabric by laminating them in.

Alternatively, the electrodes 420, 440 and electroactive layer 430 may be disposed on the fabric first before the protective layer 455 is disposed on the second electrode 440.

Alternatively, in various embodiments, instead of the gap 460, the interfacial layer 450 may also be disposed between the first electrode 420 and the fabric 410. As explained in connection with FIG. 4A. The interfacial layer 450 may be at least partially embedded into the fabric 410.

Alternatively, in various embodiments, instead of the gap 460, the first electrode 420 may directly contact the fabric 410. The first electrode 420 may be at least partially embedded into the fabric 410.

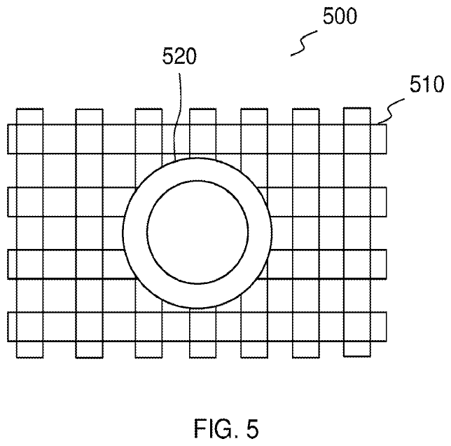

FIG. 5 shows a schematic illustration of an interactive textile 500 according to various embodiments.

In various embodiments, the interactive textile 500 may include a fabric 510. In various embodiments, the fabric 510 may have an interlaced structure, for example, the fabric may be woven. Haptic layers 520 such as electroactive layers and electrodes may be disposed on fabric 510. The haptic layers 520 may have a similar structure as the layers of FIGS. 1 to 4.

In various embodiments, an advantage of woven fabrics may be that woven fabrics, for example those made of natural yarns or non-stretch yarns, may not stretch as much as other fabrics. Another advantage of woven fabrics, for example those made of natural yarns or non-stretch yarns, may be that woven fabrics may be crisper than other fabrics. In various embodiments, woven fabrics may be suitable for making pleated fabrics. Pleated fabrics may have an advantage of larger degree of swelling/contracting and/or larger degree of shape changes which may be useful for actuating for large deformation generation.

In various embodiments, the woven fabrics may include or be substantially made of stretch yarns, for example elastane yarns. These woven fabrics including stretch yarns may be stretchable, giving larger and stable actuation performance due to their elastic and stretchable properties.

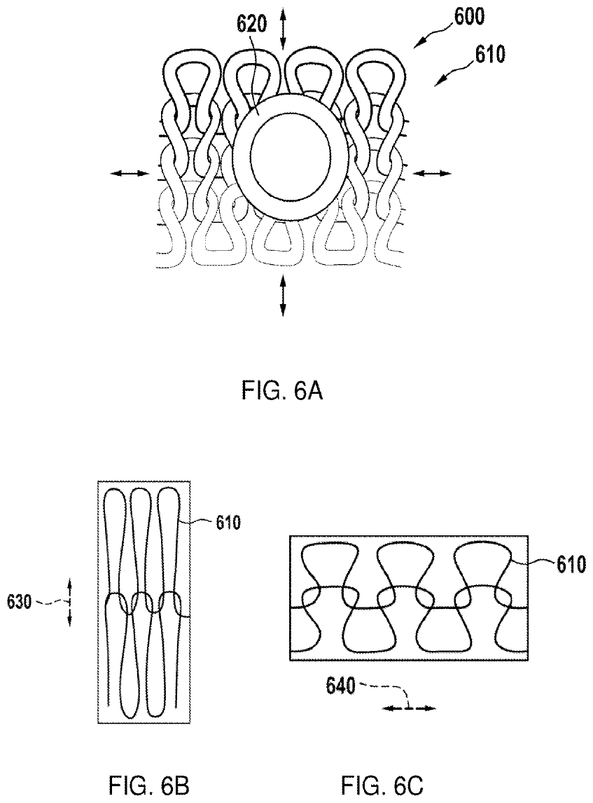

FIG. 6A shows a schematic illustration of an interactive textile 600 according to various embodiments.

In various embodiments, the interactive textile 600 may include a fabric 610. The fabric 610 may be knitted. Haptic layers 620 such as electroactive layers and electrodes may be disposed on fabric 610. The haptic layers 620 may have a similar structure as the layers of FIGS. 1 to 4.

FIGS. 6B and 6C show schematic illustrations of the stretchable properties of the interactive textile 600 according to various embodiments.

In various embodiments, the fabric 610 may be made by looping together long lengths of yarn. Fabric 610 may have an advantage of being stretchy and comfortable.

In various embodiments, the fabric 610 may be stretched in a first direction 630. In various embodiments, the fabric 610 may be stretched in a second direction 640. Advantageously, fabric 610 may allow for large vibrational strain/force generation due to its stretchable properties.

In various embodiments, the fabric may be non-woven, for example fleece. In various embodiments, non-woven fabric may have much higher surface roughness coming from its highly napped and fuzzy surface due to its entangled microfilaments. Advantageously, non-woven fabric may be good for attachment and adhesion of EAP film layers. In various embodiments, non-woven fabrics may be mechanically treated to produce a fuzzy surface. The fuzzy surface may enhance adhesion and bonding. Also, another advantage of non-woven fabric is that it is lightweight, soft, breathable, and warm. Compared to other fabrics, non-woven fabric may have better thermal insulating properties due to higher amount of air held within the entangled microfilaments. Interactive textile including haptic layers fabricated on non-woven fabric may be durable and robust.

While the present invention has been particularly shown and described with reference to specific embodiments, it should be understood by those skilled in the art that various changes in form and detail may be made therein without departing from the scope of the present invention.

1-12. (canceled)

13. An interactive textile configured to provide a haptic feedback in response to an activating signal, comprising:
a fabric;
an electroactive layer disposed on the fabric, the electroactive layer having a first main side and a second main side;
a first electrode disposed between the first main side of the electroactive layer and the fabric; and
a second electrode disposed on the second main side of the electroactive layer.

14. The interactive textile of claim 13, further comprising:
an interfacial layer disposed on the fabric.

15. The interactive textile of claim 13, wherein the haptic feedback is a vibration.

16. The interactive textile of claim 13, wherein the fabric is one of: woven, knitted, nonwoven, crocheted.

17. The interactive textile of claim 13, wherein the first electrode is arranged to be at least partially embedded into the fabric.

18. The interactive textile of claim 14, wherein the interfacial layer is arranged to be at least partially embedded into the fabric.

19. The interactive textile of claim 13, wherein a protective layer is disposed on the second electrode.

20. The interactive textile of claim 19, wherein a portion of the protective layer contacts the fabric.

21. The interactive textile of claim 13, wherein a gap layer is provided between the first electrode layer and the fabric.

22. A method of forming an interactive textile configured to provide a haptic feedback in response to an activating signal, the method comprising the following steps:
providing a fabric;
disposing a first electrode on the fabric;
disposing an electroactive layer on the first electrode; and
disposing a second electrode on the electroactive layer.

23. The method of claim 22, further comprising:
disposing an interfacial layer on the fabric, before the disposing of the first electrode.

24. The method of claim 23, further comprising:
treating a surface of the fabric before disposing the interfacial layer on the fabric.
